(19) United States
(12) Patent Application Publication
(10) Pub. No.: US 2014/0230212 A1
(43) Pub. Date: Aug. 21, 2014

(54) WELD REPAIR OF A COMPONENT

(71) Applicant: Rolls-Royce Corporation, Indianapolis, IN (US)

(72) Inventor: Quinlan Yee Shuck, Indianapolis, IN (US)

(73) Assignee: Rolls-Royce Corporation, Indianapolis, IN (US)

(21) Appl. No.: 14/102,315

(22) Filed: Dec. 10, 2013

Related U.S. Application Data
(60) Provisional application No. 61/767,090, filed on Feb. 20, 2013.

(51) Int. Cl. B23P 6/00

(52) U.S. Cl. CPC B23P 6/007
USPC 29/402.07

(57) ABSTRACT

A method for repairing a component may include machining a depression into the component. A size and a shape of the depression may be configured to remove a damaged portion of the component; and wherein the depression forms a repair volume. The method also may include depositing a plurality of continuous additive weld layers, each continuous additive weld layer of the plurality of continuous additive weld layers having a beginning point and an ending point. The beginning point and the ending point of a first continuous additive weld layer of the plurality of additive weld layers may be formed at or beyond an outer boundary of the repair volume. The beginning points and the ending points of the remainder of the plurality of continuous additive weld layers may be formed at or beyond the outer boundary of the repair volume.

This application claims the benefit of U.S. Provisional Application No. 61/767,090, filed Feb. 20, 2013, which is incorporated herein by reference in its entirety.

### TECHNICAL FIELD

The present disclosure relates to weld repair of components.

### BACKGROUND

Methods and systems that effectively weld repair components, such as gas turbine engine components, remain an area of interest. Some existing systems have various shortcomings, drawbacks, and disadvantages relative to certain applications. Accordingly, there remains a need for further contributions in this area of technology.

### SUMMARY

In one example, the disclosure describes a method for repairing a gas turbine engine component. In accordance with this example, the method may include machining a depression into the component, wherein a size and a shape of the depression are configured to remove a damaged portion of the component; and wherein the depression defines a repair volume. The method also may include depositing a plurality of continuous additive weld layers, each continuous additive weld layer of the plurality of continuous additive weld layers having a beginning point and an ending point. The beginning point and the ending point of a first continuous additive weld layer of the plurality of additive weld layers may be formed at or beyond an outer boundary of the repair volume, and the beginning points and the ending points of the remainder of the plurality of continuous additive weld layers may be formed at or beyond the outer boundary of the repair volume.

In another example, the disclosure describes a method for repairing a component. In accordance with this example, the method includes machining a depression into the component, wherein a size and a shape of the depression are configured to remove a damaged portion of the component, and wherein the depression defines a repair volume. The method also may include depositing a plurality of continuous additive weld layers, each continuous additive weld layer of the plurality of continuous additive weld layers having a beginning point and an ending point, wherein the beginning points and the ending points of each of the continuous additive weld layers are formed at or beyond an outer boundary of the repair volume.

In a further example, the disclosure describes a method for repairing a gas turbine engine component. In accordance with this example, the method may include machining a depression into the component, wherein a size and a shape of the depression are configured to remove a damaged portion of the component; and wherein the depression defines a repair volume. The method also may include a step for forming a plurality of continuous additive weld layers, each continuous additive weld layer of the plurality of continuous additive weld layers having a beginning point and an ending point, wherein the beginning points and the ending points of each continuous additive weld layer of the plurality of continuous additive weld layers are formed at or beyond an outer boundary of the repair volume.

### BRIEF DESCRIPTION OF THE DRAWINGS

The description herein makes reference to the accompanying drawings wherein like reference numerals refer to like parts throughout the several views, and wherein:

FIG. 1 is a schematic and conceptual diagram illustrating some aspects of an example weld repair system.

FIG. 2 is a schematic and conceptual diagram illustrating an example component having a depression formed therein, wherein the depression is configured to remove a damaged portion of the example component and form a repair volume.

FIG. 3 is a schematic and conceptual diagram illustrating an example component including a plurality of weld layers disposed, in part, within the repair volume.

### DETAILED DESCRIPTION

For purposes of promoting an understanding of the principles of the disclosure, reference will now be made to the examples illustrated in the drawings, and specific language will be used to describe the same. It will nonetheless be understood that no limitation of the scope of the disclosure is intended by the illustration and description of certain examples. In addition, any alterations and/or modifications of the illustrated and/or described examples are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

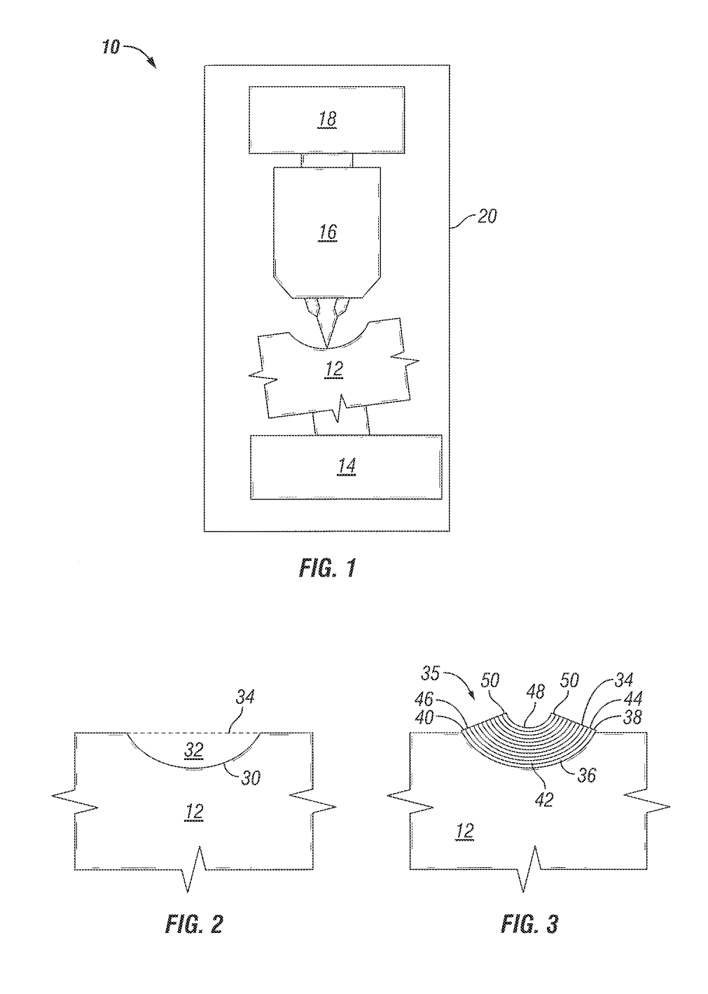

Referring to the drawings, FIG. 1 is a schematic and conceptual diagram illustrating some aspects of an example weld repair system. Weld repair system 10 is configured to repair a component 12. In some examples, component 12 is a component of a gas turbine engine. In other examples, component 12 may be a component of any engine, machine, device or system. As a gas turbine engine component, component 12 may include, for example and without limitation, a compressor or turbine blade, vane, nozzle, strut, or the like.

In some examples, weld repair system 10 includes a movable stage 14, a weld head 16, an articulating head mount 18, and an enclosure 20. In some examples, movable stage 14 is configured to rotate and/or translate component 12 during the welding process, e.g., under the control of a computer (not shown). In some examples, movable stage 14 may be manually controlled. In some examples, movable stage 14 may be configured to only rotate or only translate component 12, under computer and/or manual control. In some examples, movable stage 14 may be a fixed stage 14. Component 12 may be clamped or otherwise affixed to stage 14 by any suitable means.

Weld head 16 is configured to add material to component 12, in particular, to a repair volume, by welding (e.g., an additive weld process). Weld head 16 is configured to add weld material to component 12 in the form of continuous beads or layers, to form a plurality of layers in the repair volume. The repair volume is a volume of material, e.g., metallic material that has been removed from component 12 by damage and/or by machining component 12 to remove the damaged portion that will be filled with additive weld layers. Damage may be caused by, for example and without limitation, foreign object ingestion in an engine, unintended contact of the component with another part of the engine, machine, device or system, or may be caused by wear. In some examples, weld head 16 is configured to perform additive laser welding. For example, weld head 16 may be configured to perform direct laser deposition (DLD). In other examples, other additive weld processes and systems may be employed in addition to or in place of direct laser deposition and/or other additive laser welding processes.

In some examples, articulating head mount 18 is configured to rotate and translate weld head 16 during the welding process in order to control the location of the weld layers, and in some examples, to affect, the thickness of each layer, e.g., under the control of a computer (not shown). In other examples, articulating head mount 18 may be manually controlled. In some examples, articulating head mount 18 may be configured to only rotate or only translate weld head 16, under computer and/or manual control. In still other examples, articulating head mount 18 may be a fixed weld head mount 18.

Enclosure 20 is configured to maintain a desired atmosphere around component 12 and at least a portion of weld head 16 during the welding process. In some examples, the atmosphere is a vacuum. In other examples, the atmosphere may be a partial vacuum, an inert gas, or another desirable atmosphere. In some examples, the atmosphere may be ambient atmospheric conditions. In some examples, enclosure 20 is configured to enclose component 12, movable stage 14, weld head 16 and articulating head mount 18. In other examples, enclosure 20 may be configured to contain or enclose other volumes. Where a controlled atmosphere around the weld repair zone is desired, enclosure 20 is configured to enclose or contain, at a minimum, the volume extending from the locations on component 12 at which weld repair is desired (e.g., including the repair volume), to the nearest sealable location on weld head 16.

FIG. 2 is a schematic and conceptual diagram illustrating an example component having a depression formed therein, wherein the depression is configured to remove a damaged portion of the example component and form a repair volume. FIG. 3 is a schematic and conceptual diagram illustrating an example component including a plurality of weld layers disposed, in part, within the repair volume. Referring to FIGS. 2 and 3, in order to repair component 12, a depression 30 may be formed in component 12 at the location of the damage to component 12. In some examples, depression 30 is formed by machining In other examples, depression 30 may be formed by other processes in addition to or in place of machining In some examples, one or more of various surface treatments may be applied to the exposed surface (the surface exposed by forming depression 30), e.g., chemical etching. In some examples, depression 30 is a scallop. In other examples, depression 30 may take other forms, including, for example and without limitation, forms having a linear portion, e.g., culminating in radii or other curves at each end, or culminating in other shapes, including lines or planes, curves or other shapes at each end. In the form of a scallop, the depression 30 may be circular, elliptical, a spline or any desired shape. The size and shape of depression 30 are configured to remove the damaged portion of component 12, but may also or alternatively be configured to facilitate a good weld and/or to facilitate component integrity. Depression 30 forms a repair volume 32, which is the volume formed by depression 30 that will be filled with additive weld layers. Repair volume 32, includes an outer boundary that is the desired shape of the repaired component 12 at the location of the repair volume. In the example of FIG. 2, outer boundary 34 of repair volume 32 is depicted as a dashed line. The shape of outer boundary 34 may vary with the needs of the application, e.g., the desired shape of component 12 at the location of the weld repair, e.g., the original blueprint shape.

After depression 30 is formed and prepared, component 12 is installed onto movable stage 14. In some examples, depression 30 may be formed with component 12 already installed onto movable stage 14. The atmosphere inside enclosure 20 is formed, after which additive welding may be performed to fill in the repair volume with weld material. In some examples, weld head 16 is employed to deposit a plurality of additive weld layers. The inventors have determined that locations within the repair volume where welding is started and stopped may form potential failure sites, e.g., crack initiation sites. In order to reduce the likelihood of forming potential failure sites, examples of the present disclosure fill the repair volume with a plurality of continuous weld beads (layers) that do not have a beginning point or an ending point within the repair volume. In some examples, the beginning and ending points of the weld layers are formed at or beyond outer boundary 34, so that after post-weld machining, the beginning points and ending points are removed from component 12.

For example, with reference to FIG. 3, a weld build-up 35 is formed in depression 30. Weld build-up 5 is formed of a plurality of continuous weld layers stacked on top of each other. In the illustration of FIG. 3, a first weld layer 36 is deposited on the exposed surface of component 12 in depression 30 as follows. The starting point 38 of weld layer 36 is formed beyond outer boundary 34 of repair volume 32. Weld layer 36 is formed continuously along the surface of component 12 exposed by the formation of depression 30. In forming weld layer 36, movable stage 14 and/or articulating head mount 18 are controlled to rotate and/or translate one or both of component 12 and weld head 16, depending on the embodiment, at the appropriate relative speed and spacing in order to achieve a desirable weld. The formation of weld layer 36 is completed with an ending point 40 formed beyond outer boundary 34 of repair volume 32.

The next weld layer 42 may be deposited on top of weld layer 36. The starting point 44 of weld layer 42 is formed beyond outer boundary 34 of repair volume 32. Weld layer 42 is formed continuously along and on top of weld layer 36. In forming weld layer 42, movable stage 14 and/or articulating head mount 18 are controlled to move component 12 and weld head 16 at the appropriate relative speed and spacing in order to achieve a desirable weld. The formation of weld layer 42 is completed with an ending point 46 formed beyond outer boundary 34 of repair volume 32. Layers are repeatedly deposited on top of each other, each having beginning points and ending points that are formed at or beyond outer boundary 34 of repair volume 32, culminating in final weld layer 48 having a beginning point 50 and an end point 52 formed beyond outer boundary 34 of repair volume 32. In some examples, the beginning points and the end points of each layer may be positioned at or beyond outer boundary 34 of repair volume 32.

Some examples of the present disclosure describes a method for repairing a gas turbine engine component, comprising: machining a depression into the component, wherein a size and a shape of the depression are configured to remove a damaged portion of the component; and wherein the depression defines a repair volume; and depositing a plurality of continuous additive weld layers, each continuous additive weld layer of the plurality of continuous additive weld layers having a beginning point and an ending point, wherein the beginning point and the ending point of a first continuous additive weld layer of the plurality of additive weld layers are formed at or beyond an outer boundary of the repair volume, and wherein the beginning points and the ending points of the remainder of the plurality of continuous additive weld layers are formed at or beyond the outer boundary of the repair volume.

In some examples, the beginning points and the ending points of the remainder of the plurality of continuous additive weld layers are formed beyond the outer boundary of the repair volume.

In some examples, the beginning point and ending point of the first continuous additive weld layer are formed beyond the outer boundary of the repair volume.

In some examples, machining the depression into the component comprises machining a scallop into the component.

In some examples, machining the scallop into the component comprises machining a circular scallop into the component.

In some examples, depositing the plurality of continuous additive weld layers comprises using a weld head to deposit the plurality of continuous additive weld layers.

In some examples, using the weld head to deposit the plurality of continuous additive weld layers comprises at least one of rotating the weld head, translating the weld head, rotating the component, or translating the component to control the deposition of each continuous additive weld layer of the plurality of continuous additive weld layers.

In some examples, at least one of rotating the weld head, translating the weld head, rotating the component, or translating the component consists of translating at least one of the weld head or the component.

In some examples, at least one of rotating the weld head, translating the weld head, rotating the component, or translating the component consists of rotating at least one of the weld head or the component.

In some examples, rotating at least one of the weld head or the component consists of rotating the component.

In some examples, depositing the plurality of continuous additive weld layers comprises depositing the plurality of continuous additive weld layers using direct laser deposition.

Some examples of the present disclosure include a method for repairing a component, comprising: machining a depression into the component, wherein a size and a shape of the depression are configured to remove a damaged portion of the component, and wherein the depression defines a repair volume; and depositing a plurality of continuous additive weld layers, each continuous additive weld layer of the plurality of continuous additive weld layers having a beginning point and an ending point, wherein the beginning points and the ending points of each of the continuous additive weld layers are formed at or beyond an outer boundary of the repair volume.

In some examples, the beginning points and the ending points of each of the continuous additive weld layers are formed beyond the outer boundary of the repair volume.

In some examples, machining the depression into the component comprises machining a circular scallop into the component.

In some examples, depositing the plurality of continuous additive weld layers comprises using a weld head to deposit the plurality of continuous additive weld layers.

In some examples, using the weld head to deposit the plurality of continuous additive weld layers comprises at least one of rotating the weld head, translating the weld head, rotating the component, or translating the component to control the deposition of each of the continuous additive weld layers.

In some examples, the at least one of rotating the weld head, translating the weld head, rotating the component, or translating the component consists of translating at least one of the weld head or the component.

In some examples, the at least one of rotating the weld head, translating the weld head, rotating the component, or translating the component consists of at least one of rotating the weld head or the component.

In some examples, the rotating at least one of the weld head or the component consists of rotating the component.

Examples of the present disclosure include a method for repairing a gas turbine engine component, comprising: machining a depression into the component, wherein a size and a shape of the depression are configured to remove a damaged portion of the component; and wherein the depression defines a repair volume; and a step for forming a plurality of continuous additive weld layers, each continuous additive weld layer of the plurality of continuous additive weld layers having a beginning point and an ending point, wherein the beginning points and the ending points of each continuous additive weld layer of the plurality of continuous additive weld layers are formed at or beyond an outer boundary of the repair volume.

While the disclosure has been described in connection with illustrated examples, it is to be understood that the disclosure is not to be limited to the disclosed examples, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any example lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A method for repairing a gas turbine engine component, comprising:
machining a depression into the component, wherein a size and a shape of the depression are configured to remove a damaged portion of the component; and wherein the depression defines a repair volume; and
depositing a plurality of continuous additive weld layers, each continuous additive weld layer of the plurality of continuous additive weld layers having a beginning point and an ending point, wherein the beginning point and the ending point of a first continuous additive weld layer of the plurality of additive weld layers are formed at or beyond an outer boundary of the repair volume, and wherein the beginning points and the ending points of the remainder of the plurality of continuous additive weld layers are formed at or beyond the outer boundary of the repair volume.

2. The method of claim 1, wherein the beginning points and the ending points of the remainder of the plurality of continuous additive weld layers are formed beyond the outer boundary of the repair volume.

3. The method of claim 1, wherein the beginning point and ending point of the first continuous additive weld layer are formed beyond the outer boundary of the repair volume.

4. The method of claim 1, wherein machining the depression into the component comprises machining a scallop into the component.

5. The method of claim 4, wherein machining the scallop into the component comprises machining a circular scallop into the component.

6. The method of claim 1, wherein depositing the plurality of continuous additive weld layers comprises using a weld head to deposit the plurality of continuous additive weld layers.

7. The method of claim 6, wherein using the weld head to deposit the plurality of continuous additive weld layers comprises at least one of rotating the weld head, translating the weld head, rotating the component, or translating the component to control the deposition of each continuous additive weld layer of the plurality of continuous additive weld layers.

8. The method of claim 7, wherein at least one of rotating the weld head, translating the weld head, rotating the component, or translating the component consists of translating at least one of the weld head or the component.

9. The method of claim 7, wherein at least one of rotating the weld head, translating the weld head, rotating the component, or translating the component consists of rotating at least one of the weld head or the component.

10. The method of claim 9, wherein rotating at least one of the weld head or the component consists of rotating the component.

11. The method of claim 1, wherein depositing the plurality of continuous additive weld layers comprises depositing the plurality of continuous additive weld layers using direct laser deposition.

12. A method for repairing a component, comprising:
machining a depression into the component, wherein a size and a shape of the depression are configured to remove a damaged portion of the component, and wherein the depression defines a repair volume; and
depositing a plurality of continuous additive weld layers, each continuous additive weld layer of the plurality of continuous additive weld layers having a beginning point and an ending point, wherein the beginning points and the ending points of each of the continuous additive weld layers are formed at or beyond an outer boundary of the repair volume.

13. The method of claim 12, wherein the beginning points and the ending points of each of the continuous additive weld layers are formed beyond the outer boundary of the repair volume.

14. The method of claim 12, wherein machining the depression into the component comprises machining a circular scallop into the component.

15. The method of claim 12, wherein depositing the plurality of continuous additive weld layers comprises using a weld head to deposit the plurality of continuous additive weld layers.

16. The method of claim 15, wherein using the weld head to deposit the plurality of continuous additive weld layers comprises at least one of rotating the weld head, translating the weld head, rotating the component, or translating the component to control the deposition of each of the continuous additive weld layers.

17. The method of claim 16, wherein the at least one of rotating the weld head, translating the weld head, rotating the component, or translating the component consists of translating at least one of the weld head or the component.

18. The method of claim 16, wherein the at least one of rotating the weld head, translating the weld head, rotating the component, or translating the component consists of at least one of rotating the weld head or the component.

19. The method of claim 18, wherein the rotating at least one of the weld head or the component consists of rotating the component.

20. A method for repairing a gas turbine engine component, comprising:
machining a depression into the component, wherein a size and a shape of the depression are configured to remove a damaged portion of the component; and wherein the depression defines a repair volume; and
a step for forming a plurality of continuous additive weld layers, each continuous additive weld layer of the plurality of continuous additive weld layers having a beginning point and an ending point, wherein the beginning points and the ending points of each continuous additive weld layer of the plurality of continuous additive weld layers are formed at or beyond an outer boundary of the repair volume.
